(19) United States
(12) Patent Application Publication
(10) Pub. No.: US 2008/0212692 A1
(43) Pub. Date: Sep. 4, 2008

(54) Method and apparatus for multimode, point to multipoint base station capable of supporting both OFDM and OFDMA subscribers

(75) Inventors: Raja Banerjea, Sunnyvale, CA (US); Russell Raymond Reynolds, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Proxim Wireless Corporation, San Jose, CA (US)

(21) Appl. No.: 11/594,051

(22) Filed: Nov. 6, 2006

(51) Int. Cl. H04L 27/28

(52) U.S. Cl. 375/260

(57) ABSTRACT

A method and system for providing multilingual wireless communications network are disclosed. The present invention discloses a mechanism of receiving and/or transmitting an OFDM data stream using IEEE 802.16-2004 standard and an OFDMA data stream using IEEE 802.16e standard. A timing division duplexing (“TDD”) frame is configured to contain data that has different standards. At least a portion of OFDM data is allocated in a portion of the TDD frame while a portion of OFDMA data is allocated in another portion of the TDD frame. The TDD frame is subsequently transmitted to both OFDM subscriber stations and OFDMA subscriber stations.

### FIELD OF THE INVENTION

The present invention relates to communications network. More specifically, the present invention relates wireless communications network.

### BACKGROUND OF THE INVENTION

In recent years, the transfer of information over the wireless communications network based on the IEEE 802.16 standard has been increasing popularity for digital terrestrial television broadcasting, mobile communications and the like. The IEEE 802.16 standard includes the IEEE 802.16-2004 standard, which is mainly directed to fixed applications, and the IEEE 802.16e standard, which is typically directed to mobile applications. The IEEE 802.16-2004 standard is based on an orthogonal frequency-division multiplexing (“OFDM”) PHY (physical layer) and is directed to fixed broadband wireless applications. The IEEE 802.16e standard is based on an orthogonal frequency-division multiplex access (“OFDMA”) PHY, and is directed to mobile broadband wireless applications.

A problem of implementing with both the IEEE 802.16-2004 standard and the IEEE 802.16e standard is that there is no provision or mechanism in these standards to interoperate with each other. An IEEE 802.16-2004 standard base station typically supports the IEEE 802.16-2004 standard subscriber stations while an IEEE 802.16e standard base station generally supports the IEEE 802.16e standard subscriber stations.

Accordingly, there is a need in the art to provide a mechanism of implementing (or transmitting) information in both IEEE 802.16-2004 standard as well as the IEEE 802.16e standard.

### SUMMARY OF THE INVENTION

The present invention discloses a multilingual wireless communications network that is capable of supporting multiple wireless communication standards simultaneously. In one embodiment, the communication network provides a mechanism of receiving and/or transmitting an OFDM data stream using IEEE 802.16-2004 standard and an OFDMA data stream using IEEE 802.16e standard at substantially the same time. A timing division duplexing (“TDD”) frame is configured to contain data having different standards. At least a portion of OFDM data is allocated in a portion of the TDD frame while a portion of OFDMA data is allocated in another portion of the TDD frame. The TDD frame is subsequently transmitted to both OFDM subscriber stations and OFDMA subscriber stations.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a multilingual wireless communications system in accordance with one embodiment of the present invention;

FIG. 2 is a block diagram illustrating TDD or FDD frames containing data formatted in different air interface broadband wireless standards in accordance with one embodiment of the present invention;

FIG. 3 is a block diagram illustrating a frame carrying OFDM data and OFDMA data in accordance with one embodiment of the present invention;

FIG. 4 is a copy in accordance with one embodiment of the present invention; and

FIG. 5 is a flowchart illustrating a process of providing multilingual wireless broadband standards in accordance with one embodiment of the present invention.

### DETAILED DESCRIPTION

A method and system for providing multilingual wireless communications network are disclosed.

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice to present invention. In other instances, well-known circuits and devices are shown in block diagram form to avoid obscuring the present invention. In the following description of the embodiments, substantially the same parts are denoted by the same reference numerals.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The present invention discloses a multilingual wireless communications system that is capable of supporting multiple air interface wireless communication standards simultaneously. In one embodiment, the communication system provides a mechanism of receiving and/or transmitting an OFDM data stream using IEEE 802.16-2004 standard and an OFDMA data stream using IEEE 802.16e standard at substantially the same time. The OFDM data indicates data formatted in OFDM using IEEE 802.16-2004 standard. The OFDMA data means data formatted in OFDMA using IEEE 802.16e. standard. The present invention includes composing a series of timing division duplexing (“TDD”) frames to contain data formatted different standards. For example, a portion of OFDM data is allocated in a portion of a TDD frame while a portion of OFDMA data is allocated in another portion of the TDD frame. The TDD frame, which includes the OFDM data and the OFDMA data, is subsequently transmitted to both OFDM subscriber stations and OFDMA subscriber stations.

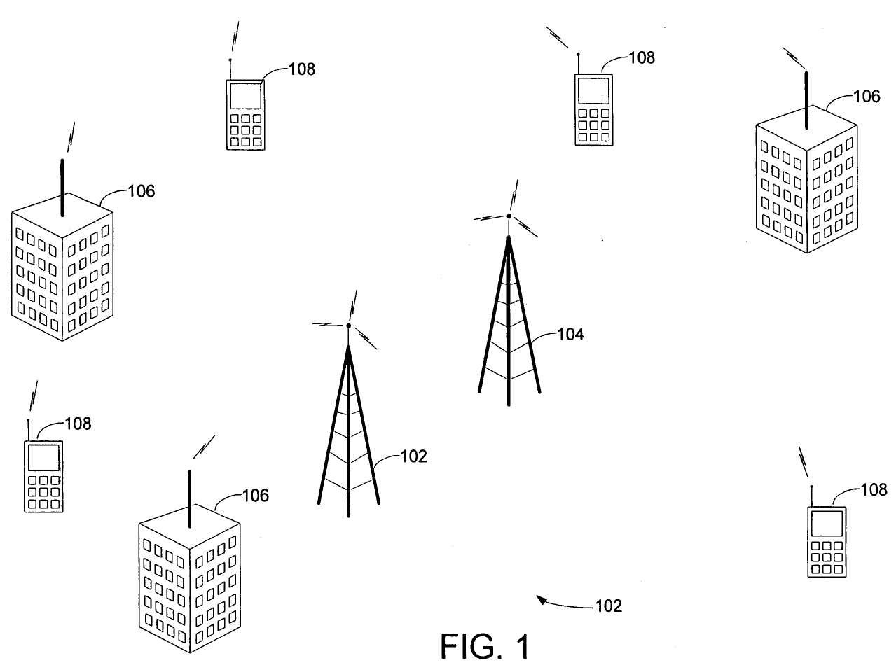

FIG. 1 is a block diagram illustrating a multilingual wireless communications system 100 in accordance with one embodiment of the present invention. System 100, in one aspect, is a wireless metropolitan area network (“WiMAN”) wherein it, in this example, includes two base stations 102-104, fixed subscriber stations 106 and mobile subscribers 108. Base stations 102-104 can be alternatively combined into one base station. In one embodiment, each of base stations 102-104 is capable of receiving and/or transmitting data using the IEEE 802.16-2004 air interface standard and IEEE 802.16e air interface standard. In another embodiment, base station 102 is configured to receive and/or transmit data with the IEEE 802.16-2004 standard while base station 104 is configured to receive and/or transmit data with the IEEE 802.16e standard.

Fixed subscribers stations 106 (“SS”) may be buildings, towers, and/or any other types of fixed structures whereby they are capable of distributing wireless signals from base stations 102-104 to the vicinity and/or surroundings of SS 106. The wireless signals include data, video, real-time videoconference, gaming applications, and/or voice information. In one embodiment, the SS 106 use the IEEE 802.16.2004 air interface standard to transmit and/or receive the signals. Mobile subscribers 108 (“MS”) may be cellular phones, personal digital assistants (“PDAs”), smart phones, laptop computers, et cetera, and are capable of communicating the wireless signals between base stations 102-104 and MS 108. In one embodiment, base station 104 is specifically designated to employ the IEEE 802.16e air interface standard to transmit or receive data or wireless signals to and from MS 108.

The bilingual base stations or multilingual base stations may be implemented as either a single based station or as multiple base stations. If base stations are used as bilingual base stations, one base station, such as base station 104, uses the OFDMA modulation with the IEEE 802.16e standard to communicate with various MS 108, while the other base station, such as base station 102, uses the OFDM modulation with the IEEE 802-2004 standard for communicate with various SS 106. To operate multiple bilingual or multilingual wireless communications, multilingual base stations such as base stations 102-104 need to be synchronized with each other. In one embodiment, a synchronizing device is used to generate timing pulses to sync the base stations. For example, a timing pulse may be used to indicate the start of transmitting the OFDM frame(s). The timing pulses, in one embodiment, are generated by one of the two base stations. Alternatively, the synchronizing device can be an external device (e.g., GPS receiver), which provides wireless data transmission between the base stations.

The IEEE 802.16-2004 standard defines a TDMA-based OFDM point to multipoint system, and the IEEE 802.16e standard defines the use of OFDMA in the point to multipoint system. The standards further define time division duplex (“TDD”) and frequency division duplex (“FDD”) for time or frequency allocations. The media time is organized as a sequence of equal size frames wherein each frame is further divided into a number of subframes with varying sizes. In TDD, each frame includes a downlink portion followed by an uplink portion, wherein the downlink and uplink portions share a single frequency. Each downlink subframe is configured to begin with a preamble, which identifies the start of frame. Similarly, uplink subframes also begin with a preamble. The downlink transmission contains the allocation intervals or subframes for the individual uplink transmissions (from the subscriber station) as well as downlink transmissions (to the subscriber stations). On the other hand, FDD uses one frequency for uplink transmissions and another frequency for downlink transmissions. The base station, in one embodiment, transmits downlink data and uplink data at substantially the same time. It should be noted that frame duration is generally fixed, which could be 2.5, 4, 5, 8, 10, 12.5, or 20 ms as indicated by the IEEE 802.16 standard.

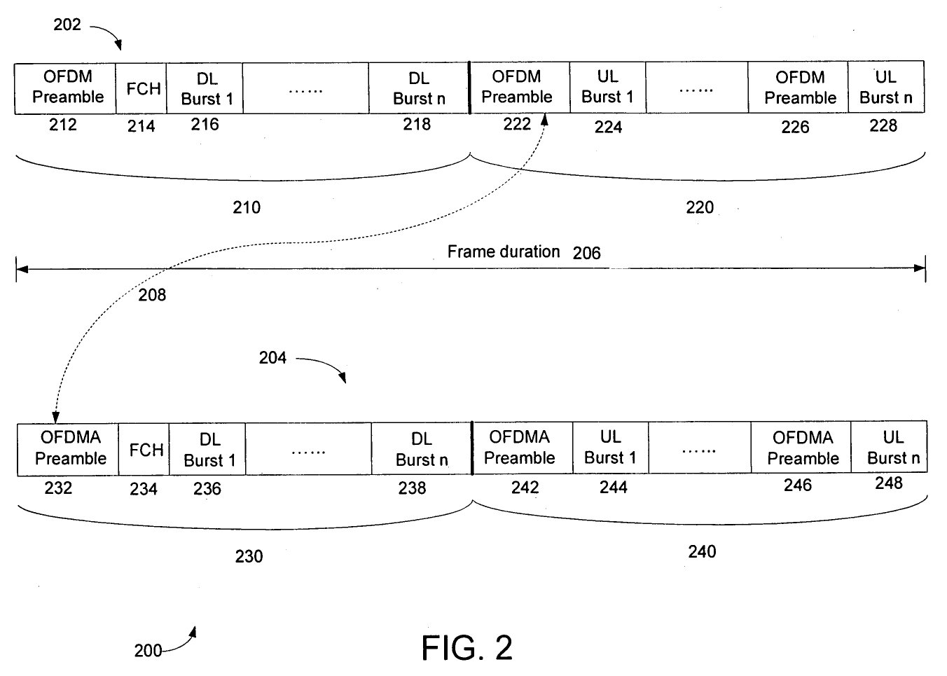

FIG. 2 is a block diagram 200 illustrating TDD or FDD frames capable of containing data formatted in different air interface broadband wireless standards in accordance with one embodiment of the present invention. Diagram 200 includes an OFDM subframe 202 and an OFDMA subframe 204 wherein subframe 202 further includes a downlink portion 210 and an uplink portion 220. In one embodiment, downlink portion 210 and uplink portion 220 are not necessary the same length. In other words, downlink portion 210 can occupy larger physical portions of OFDM subframe 202 than uplink portion 220. Downlink portion 210 also includes multiple subframes including an OFDM preamble 212, a frame control header (“FCH”) 214, and downlink bursts (1 . . . n) 216-218. Uplink portion 220 includes multiple pairs of preambles and uplink bursts, such as OFDM preambles 222-226 and uplink bursts (1 . . . n) 224-228. Burst transmission, in one aspect, means data transmission with high data signaling rate within a defined transmission time.

OFDMA subframe 204 includes a downlink portion 230 and an uplink portion 240 wherein downlink portion 230 and uplink portion 240 can be different in length. Downlink portion 230 also includes multiple subframes including an OFDMA preamble 232, a frame control header (“FCH”) 234, and downlink bursts (1 . . . n) 236-238. Also, uplink portion 240 includes multiple pairs of preambles and bursts, such as OFDMA preambles 242-246 with uplink bursts (1 . . . n) 244-248. To implement multilingual capabilities, uplink portion 220 and downlink portion 230, in one embodiment, are swapped as indicated by a dotted line 208. It should be noted that the frame duration 206 can be 2-5, 4, 5, 8, 10, 12.5 or 20 milliseconds (“ms”).

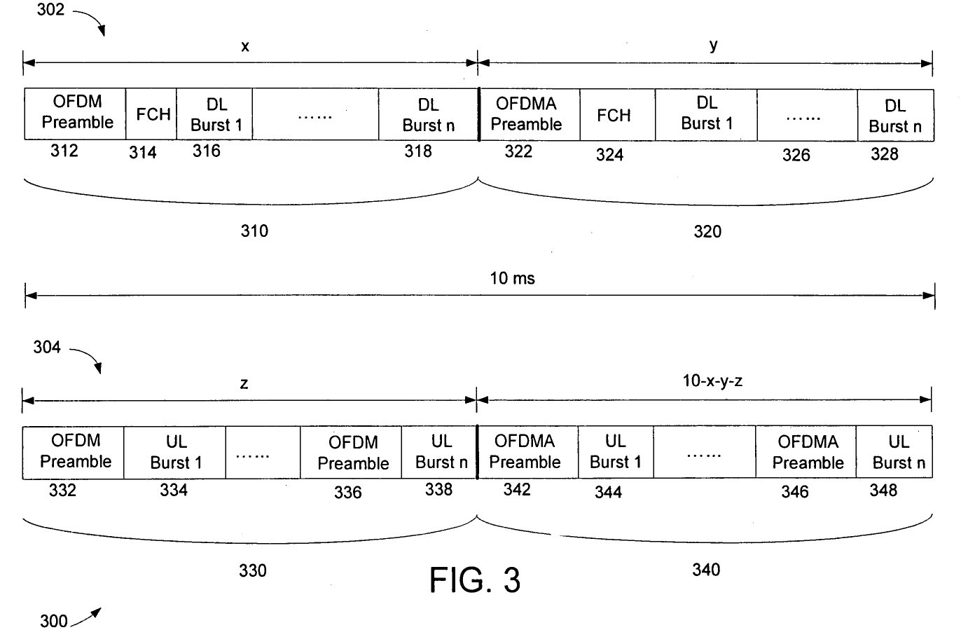

FIG. 3 is a block diagram 300 illustrating a frame containing both OFDM data and OFDMA data in accordance with one embodiment of the present invention. The OFDM data, as mentioned earlier, indicates data formatted in OFDM using IEEE 802.16-2004 standard. The OFDMA data means data formatted in OFDMA using IEEE 802.16e standard. Diagram 300 includes a downlink subframe 302 and an uplink subframe 304 wherein downlink subframe 302 further includes an OFDM downlink portion 310 and an OFDMA downlink portion 320. In one embodiment, OFDM downlink portion 310 and OFDMA downlink portion 320 have different lengths. OFDM downlink portion 310 also includes multiple subframes including an OFDM preamble 312, an FCH 314, and multiple downlink bursts (1 . . . n) 316-318. OFDMA downlink portion 320 includes an OFDMA preamble 322, an FCH 324, and multiple downlink bursts (1 . . . n) 326-328.

Similarly, uplink frame 304 includes an OFDM uplink portion 330 and an OFDMA uplink portion 340 wherein OFDM uplink portion 330 includes multiple pairs of preambles and bursts such as OFDM preambles 332-336 with uplink bursts (1 . . . n) 334-338. Also, OFDMA uplink portion 340 includes multiple pairs of preambles and bursts such as OFDMA preambles 342-346 with uplink burst (1 . . . n) 344-348. It should be noted that the frame duration 306 is 10 ms.

An advantage of the present invention is to simultaneously support multiple air interface standards for wireless communications, such as the IEEE 802.16-2004 standard and the IEEE 802.16e standard. In one embodiment, a multilingual system transmits the OFDM data together with the OFDMA data in an alternative time interval. To support the multiple standards, the base station allocates a portion of time in the IEEE 802.16-2004 downlink map to the IEEE 802.16e downlink and a portion of time in the IEEE 802.16e downlink map to the IEEE 802.16-2004 downlink. Similarly, in the IEEE 802.16-2004 uplink map, the base station allocates time for the IEEE 802.16e uplink and in the IEEE 802.16e uplink map, the base station allocates time for the IEEE 802.16-2004 uplink.

All base stations, in one aspect, are configured to implement the same frame size and the same offset values, which is used to indicate a portion of a frame. As shown in FIG. 3, an offset value x indicates a portion of a frame that is used for transmitting the OFDM downlink data 310 while the offset value y indicates a portion of a frame that is used for transmitting the OFDMA downlink data 320. Also, the offset value z indicates a portion of a frame that is used for transmitting the OFDM uplink data 330 while the remaining portion of the frame (i.e., remaining duration=frame duration-x-y-z) is used for transmitting the OFDMA uplink data 340. If the frame during is 10 ms, the 10 ms-frame is divided among OFDM DL (x ms), OFDMA DL (y ms), OFDM UL (z ms), and OFDMA UL (10-x-y-z ms).

In one embodiment, the OFDM base station, such as base station 102 shown in FIG. 1, begins its downlink portion transfer at the beginning of the timing pulse, and the OFDMA base stations, such as base station 104 shown in FIG. 1, begins its downlink portion transfer at x milliseconds after the timing pulse. In this example, the OFDM base station communicates with the OFDM subscriber stations, and the OFDMA base station communicates with the OFDMA mobile subscriber stations. If, for example, the frame during is 10 ms, the frame is divided among OFDM DL (x ms), OFDMA DL (y ms), OFDM UL (z ms), and OFDMA UL (10-x-y-z ms). In one embodiment, x, y, and z can be selected to flexibly allocate bandwidth amongst OFDM downlink, OFDMA downlink, OFDM uplink, and OFDMA uplink.

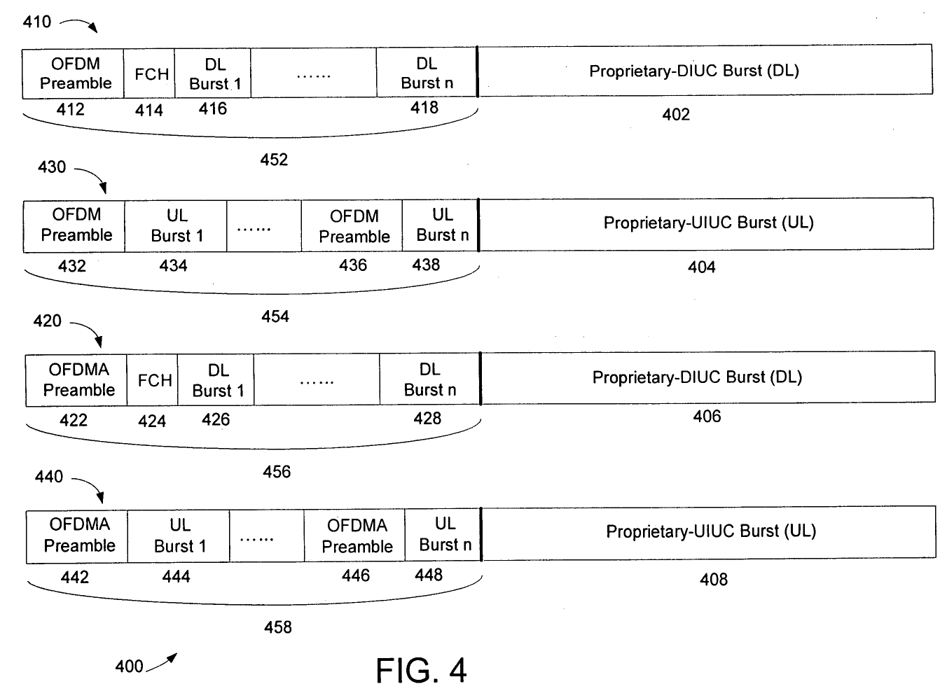

FIG. 4 illustrates a block diagram 400 employing interval usage code to mask bilingual frames in accordance with one embodiment of the present invention. Diagram 400 shows an OFDM downlink subframe 410, an OFDM uplink subframe 430, an OFDMA downlink subframe 420, and an OFDMA uplink subframe 440. OFDM downlink subframe 410 includes an OFDM preamble 412, an FCH 414, multiple downlink bursts (1 . . . n) 416-418, and a proprietary downlink interval usage code (“DIUC”) burst 402. OFDMA downlink subframe 420 includes an OFDMA preamble 422, an FCH 424, multiple downlink burst (1 . . . n) 426-428, and a proprietary uplink interval usage code (“UIUC”) burst 406. OFDM uplink subframe 430 includes multiple pairs of OFDM preambles 432-436 and uplink burst (1 . . . n) 434-438, and a proprietary-DIUC 404. OFDMA uplink portion 440 includes multiple pairs of OFDMA preambles 442-446 and uplink bursts (1 . . . n) 444-448, and a proprietary-UIUC burst 408.

Since the OFDM data uses the IEEE 802.16-2004 standard and the OFDMA data uses 802.16e standard, both, in one embodiment, require continuous allocations throughout the frame. Each bilingual base station is required to load appropriate downlink maps (FCH+DL-Maps) and uplink maps (UL-Maps) to broadcast the IEEE 802.16e standard allocations to the IEEE 802.16-2004 subscriber stations as well as the IEEE 802.16-2004 standard allocations to the IEEE 802.16e subscriber stations. In this embodiment, the OFDMA of IEEE 802.16e section of the downlink subframe is identified to the OFDM of IEEE 802.16-2004 subscribers as a proprietary extended DIUC in the OFDM map. When DIUC is transmitted, the IEEE 802.16 compliant OFDM subscribers will not recognize this DIUC, and should neither transmit nor receive the DIUC during this interval. Similarly, the OFDM uplink is identified to OFDMA subscriber stations as a proprietary extended DIUC and the OFDMA uplink is identified to OFDM subscribers as a proprietary UIUC. Also, the OFDM downlink is identified to OFDMA subscribers as a proprietary UIUC.

In operation, OFDM subscribers transmit/receive information during intervals 452-454 and ignore the information during intervals 402-404. Similarly, OFDMA subscribers transmit/receive information during intervals 456-458 and ignore the information during intervals 406-408. The OFDMA proprietary DIUC is used to protect the OFDM uplink subframes while OFDMA proprietary UIUC is used to protect OFDM downlink subframes.

It should be noted that a similar implementation may be employed with FDD. In the FDD operation, the uplink and downlink frequencies are individually time-divided between OFDM and OFDMA. Again, proprietary DIUCs and UIUCs may be used to signal proprietary information to subscriber stations.

The present invention includes various processing steps, which will be described below. The steps of the present invention may be embodied in machine or computer executable instructions. The instructions can be used to cause a general purpose or special purpose system, which is programmed with the instructions to perform the steps of the present invention. Alternatively, the steps of the present invention may be performed by specific hardware components that contain hard-wired logic for performing the steps, or by any combination of programmed computer components and custom hardware components. While embodiments of the present invention will be described with reference to wireless communications network, the method and apparatus described herein is equally applicable to other network infrastructures or other data communications environments.

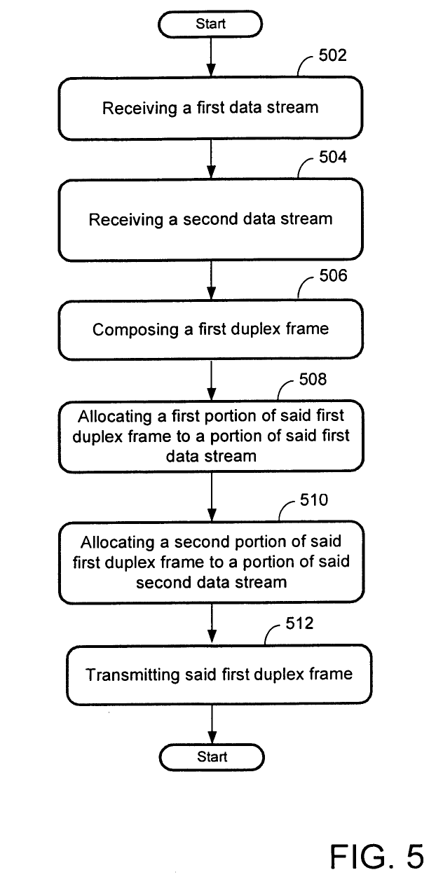

FIG. 5 is a flowchart illustrating a process of providing multilingual wireless broadband standards in accordance with one embodiment of the present invention. At block 502, the process receives a first data stream formatted in a first air interface broadband wireless standard (“AIBWS”). In one embodiment, the first AIBWS is the IEEE 802.16-2004 standard. After block 502, the process moves to the next block.

At block 504, the process receives a second data stream formatted in a second AIBWS. In one embodiment, the second AIBWS is the IEEE 802.16e standard. The process then moves to the next block.

At block 506, the process composes a first duplex subframe, which contains downlink information. In one embodiment, the process also composes a second duplex subframe that contains uplink information. The first and second duplex subframes are time division duplexing subframes. In another embodiment, the first and second duplex subframes are frequency division duplexing frames. The process proceeds to the next block.

At block 508, the process allocates a first portion of first duplex subframe to a portion of first data stream with a first multiplexing modulation. In one embodiment, the process loads a portion of a first data stream, which is the OFDM data, in a portion of first duplex subframe using the IEEE 802.16-2004 standard with the OFDM modulation. In another embodiment, the process allocates a portion of second duplex subframe to a portion of OFDM data with the IEEE 802.16-2004 standard with the OFDM modulation. The process, in one aspect, allocates preambles and frame control header in the first duplex subframe. The process proceeds to the next block.

At block 510, the process allocates a second portion of first duplex subframe to a portion of second data stream, which is OFDMA data, with a second multiplexing modulation. In one embodiment, the second multiplexing modulation is the IEEE 802.16e using OFDMA modulation. The process moves to the next block.

At block 512, the process transmits the first duplex subframe to OFDM subscribers, who are capable of receiving and transmitting data with the IEEE 802.16-2004 standard and OFDMA subscribers, who are capable of receiving and transmitting data with the IEEE 802.16e standard. In one embodiment, the process also transmits a second duplex subframe to the IEEE 802.16-2004 subscribers and the IEEE 802.16e subscribers. For example, the process is capable of transmitting duplexing frames, which include the first and second duplex subframes, to a fixed subscriber station using the IEEE 802.16-2004 standard with OFDM modulation and a mobile subscriber using the IEEE 802.16e standard with OFDMA modulation at substantially the same time.

It should be noted that the present application should be applicable to any types of air interface broadband wireless standards including, not limited to, the IEEE 802.16-2004 standard or the IEEE 802.16e standard.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

What is claimed is:

1. A method for wireless communications system comprising:
receiving a first data stream formatted in a first air interface broadband wireless standard (“AIBWS”);
receiving a second data stream formatted in a second AIBWS;
composing a first duplex subframe containing downlink information;
allocating a first portion of said first duplex subframe to at least a portion of said first data stream with a first multiplexing modulation;
allocating a second portion of said first duplex subframe to at least a portion of said second data stream with a second multiplexing modulation; and
transmitting said first duplex subframe to a first subscriber capable of receiving and transmitting data with said first AIBWS, and a second subscriber capable of receiving and transmitting data with said second AIBWS.

2. The method of claim 1 further includes:
composing a second duplex subframe containing uplink information;
allocating a first portion of said second duplex subframe to at least a portion of said first data stream with said first multiplexing modulation;
allocating a second portion of said second duplex subframe to at least a portion of said second data stream with said second multiplexing modulation; and
transmitting said second duplex subframe to said first subscriber and said second subscriber.

3. The method of claim 2,
wherein said receiving a first data stream formatted in a first AIBWS includes identifying said first data stream with IEEE 802.16-2004 standard; and
wherein said receiving a second data stream formatted in a second AIBWS includes identifying said second data stream with IEEE 802.16e standard.

4. The method of claim 3, wherein said allocating a first portion of said first duplex subframe to at least a portion of said first data stream with a first multiplexing modulation further includes loading said portion of said first data stream in said first portion of said first duplex subframe utilizing IEEE 802.16-2004 with Orthogonal Frequency Division Multiplexing (“OFDM”) modulation.

5. The method of claim 4, wherein said allocating a second portion of said first duplex subframe to at least a portion of said second data stream with a second multiplexing modulation further includes loading said portion of said second data stream in said second portion of said first duplex subframe utilizing IEEE 802.16-e with Orthogonal Frequency Division Multiple Access (“OFDMA”) modulation.

6. The method of claim 5, wherein transmitting said first duplex subframe to a first subscriber complied with said first AIBWS and a second subscriber complied with said second AIBWS further includes sending said first duplex subframe to a fixed subscriber station utilizing IEEE 802.16-2004 with OFDM modulation and a mobile subscriber utilizing IEEE 802.16e with OFDMA modulation at substantially same time.

7. The method of claim 2,
wherein said composing a first duplex subframe further including setting said first duplex subframe to time division duplexing; and
wherein said composing a second duplex subframe further including setting said first duplex subframe to time division duplexing.

8. The method of claim 2,
wherein said composing a first duplex subframe further including setting said first duplex subframe to frequency division duplexing; and
wherein said composing a second duplex subframe further including setting said first duplex subframe to frequency duplexing.

9. The method of claim 1, wherein said allocating a first portion of said first duplex subframe to include at least a portion of said first data stream further includes allocating a preamble and a frame control header in said portion of said first duplex subframe.

10. A multilingual wireless communications system, comprising:
a synchronizing device capable of generating a timing pulse;
a first base station coupled to said synchronizing device and configured to transmit data, which is formatted in Orthogonal Frequency Division Multiplexing (“OFDM”) under IEEE 802.16-2004 standard, at a first time associated with said timing pulse; and
a second base station coupled to said first station and configured to transmit data, which is formatted in Orthogonal Frequency Division Multiple Access (“OFDMA”) under IEEE 802.16e standard, at a second time associated with said timing pulse.

11. The system of claim 10, wherein said first time and said second time are mutually exclusive time periods.

12. The system of claim 11, wherein said first base station stops transmitting data before said second time.

13. The system of claim 12, wherein said first time is triggered by said timing pulse and wherein said second time is triggered by a predefined time period after said timing pulse.

14. The system of claim 13, wherein said first time plus said second time substantially equal to a frame duration.

15. The system of claim 10, wherein said first base station and second base station are implemented in a same main base station.

16. The system of claim 10, wherein said first base station communicates with OFDM subscriber stations.

17. The system of claim 16, wherein said second base station communicates with OFDMA subscriber stations.

18. The system of claim 10, wherein said synchronizing device is implemented in first base station, which communicates said timing pulse to said second base station.

19. The system of claim 10, wherein said data formatted in OFDM and said data formatted in OFDMA share same frame duration.

20. An apparatus for providing wireless communications network comprising:
means for receiving a first data stream formatted in a first air interface broadband wireless standard (“AIBWS”);
means for receiving a second data stream formatted in a second AIBWS;
means for composing a first duplex subframe containing downlink information;
means for allocating a first portion of said first duplex subframe to at least a portion of said first data stream with a first multiplexing modulation;
means for allocating a second portion of said first duplex subframe to at least a portion of said second data stream with a second multiplexing modulation; and
means for transmitting said first duplex subframe to a first subscriber capable of receiving and transmitting data with said first AIBWS, and a second subscriber capable of receiving and transmitting data with said second AIBWS.

21. The apparatus of claim 20 further includes:
means for composing a second duplex subframe containing uplink information;
means for allocating a first portion of said second duplex subframe to at least a portion of said first data stream with said first multiplexing modulation;
means for allocating a second portion of said second duplex subframe to at least a portion of said second data stream with said second multiplexing modulation; and
means for transmitting said second duplex subframe to said first subscriber and said second subscriber.

22. The apparatus of claim 21,
wherein said means for receiving a first data stream formatted in a first AIBWS includes means for identifying said first data stream with IEEE 802.16-2004 standard; and
wherein said means for receiving a second data stream formatted in a second AIBWS includes means for identifying said second data stream with IEEE 802.16e standard.

23. The apparatus of claim 22, wherein said means for allocating a first portion of said first duplex subframe to at least a portion of said first data stream with a first multiplexing modulation further includes means for loading said portion of said first data stream in said first portion of said first duplex subframe utilizing IEEE 802.16-2004 with Orthogonal Frequency Division Multiplexing (“OFDM”) modulation.

24. The apparatus of claim 23, wherein said means for allocating a second portion of said first duplex subframe to at least a portion of said second data stream with a second multiplexing modulation further includes means for loading said portion of said second data stream in said second portion of said first duplex subframe utilizing IEEE 802.16-e with Orthogonal Frequency Division Multiple Access (“OFDMA”) modulation.

25. The apparatus of claim 24, wherein said means for transmitting said first duplex subframe to a first subscriber complied with said first AIBWS and a second subscriber complied with said second AIBWS further includes means for sending said first duplex subframe to a fixed subscriber station utilizing IEEE 802.16-2004 with OFDM modulation and a mobile subscriber utilizing IEEE 802.16e with OFDMA modulation at substantially same time.

26. The apparatus of claim 21,
wherein said means for composing a first duplex subframe further including means for setting said first duplex subframe to time division duplexing; and
wherein said means for composing a second duplex subframe further including means for setting said first duplex subframe to time division duplexing.

27. The apparatus of claim 21,
wherein said means for composing a first duplex subframe further including means for setting said first duplex subframe to frequency division duplexing; and
wherein said means for composing a second duplex subframe further including means for setting said first duplex subframe to frequency duplexing.

28. The apparatus of claim 20, wherein said means for allocating a first portion of said first duplex subframe to include at least a portion of said first data stream further includes means for allocating a preamble and a frame control header in said portion of said first duplex subframe.

29. An article of manufacture for use in a digital processing system for transmitting information over IEEE 802.16-2004 and IEEE 802.16e air interface standards in substantially same data stream, the article of manufacture comprising a digital processing system usable medium having readable program code embodied in the medium, the program code comprising:
receiving a first data stream formatted in a first air interface broadband wireless standard (“AIBWS”);
receiving a second data stream formatted in a second AIBWS;
composing a first duplex subframe containing downlink information;
allocating a first portion of said first duplex subframe to at least a portion of said first data stream with a first multiplexing modulation;
allocating a second portion of said first duplex subframe to at least a portion of said second data stream with a second multiplexing modulation; and
transmitting said first duplex subframe to a first subscriber capable of receiving and transmitting data with said first AIBWS, and a second subscriber capable of receiving and transmitting data with said second AIBWS.

30. The article of claim 29 further includes:
composing a second duplex subframe containing uplink information;
allocating a first portion of said second duplex subframe to at least a portion of said first data stream with said first multiplexing modulation;
allocating a second portion of said second duplex subframe to at least a portion of said second data stream with said second multiplexing modulation; and
transmitting said second duplex subframe to said first subscriber and said second subscriber.

31. The article of claim 30,
wherein said receiving a first data stream formatted in a first AIBWS includes identifying said first data stream with IEEE 802.16-2004 standard; and
wherein said receiving a second data stream formatted in a second AIBWS includes identifying said second data stream with IEEE 802.16e standard.

32. The article of claim 31, wherein said allocating a first portion of said first duplex subframe to at least a portion of said first data stream with a first multiplexing modulation further includes loading said portion of said first data stream in said first portion of said first duplex subframe utilizing IEEE 802.16-2004 with Orthogonal Frequency Division Multiplexing (“OFDM”) modulation.
